(19) United States
(12) Patent Application Publication
(10) Pub. No.: US 2003/0097892 A1
(43) Pub. Date: May 29, 2003

(54) SHIFT LEVER AND METHOD FOR MANEUVERING AN AUTOMATIC TRANSMISSION

(75) Inventor: Anders HEDMAN, Marstrand (SE)

(73) Assignee: Volvo Lastvagnar AB, Goteborg, S-405 08 (SE)

(21) Appl. No.: 10/248,708

(22) Filed: Feb. 11, 2003

Related U.S. Application Data
(63) Continuation of application No. PCT/SE01/01713, filed on Aug. 6, 2001, now abandoned.

(30) Foreign Application Priority Data
Aug. 11, 2000 (SE) 0002870-4

(51) Int. Cl. F16H 59/02

(52) U.S. Cl. 74/335

(57) ABSTRACT

### Abstract of Disclosure

Method and arrangement including a gearshift (22) for operating an automated transmission (11, 12) of a motor vehicle that includes a disengagement arrangement (12) positioned in the drive line between the engine (10) and the gearbox (11) of the vehicle. The gearbox can be operated between a neutral position and at least one drive position by operating the gearshift between a corresponding neutral position (N) and at least one corresponding drive position (D). In order to make possible rapid operation of the gearbox, a detector is arranged so as to detect an actuation of the gearshift (22), and the detector is connected to operating means (17, 18) for activating the disengagement arrangement (12).

### Cross Reference to Related Applications

This application is a continuation patent application of International Application No. PCT/SE01/01713, filed 6 August 2001 which was published in English pursuant to Article 21(2) of the Patent Cooperation Treaty, and which claims priority to Swedish Application No. 0002870-4, filed 11 August 2000. Both applications are expressly incorporated herein by reference in their entireties.

### Background of Invention

TECHNICAL FIELD: The present invention relates to a gearshift for operating an automatic transmission for a motor vehicle that includes a disengagement arrangement positioned in the drive line between the engine and the transmission of the vehicle; the transmission being of a type that can be operated between a neutral position and at least one drive position by operating the gearshift between a corresponding neutral position and at least one corresponding drive position. The invention also relates to a method for operating an automated transmission of similar type.

BACKGROUND: Automated gearboxes have recently become increasingly common in trucks. Such gearboxes are in principle manual gearboxes in which the gear lever has been replaced by an automation means. This includes both electronics for selection of a new gear and actuators for engaging and disengaging the gears.

In a vehicle with an automated gearbox, there is no conventional gear lever in the driver's compartment; instead, there is a gear selector with electric changeover switches for detecting the gear position selected.

When a gearbox is operated from one gear position to another, the old gear position must first be disengaged from the engagement position. The speed of rotation of the running wheels of the new gear position must then be speed-adapted to one another before these running wheels can be brought together. In manual gearboxes, this speed adaptation is, as a rule, brought about by synchronizing devices that serve as a brake between a clutch sleeve and the running wheels. For reasons of cost, these synchronizing devices are often removed in automated gearboxes. Speed adaptation is then achieved by controlling the speed of rotation of the engine, which means that the clutch does not have to be disengaged on shifting gears when the vehicle is in motion.

In order to speed up the speed adaptation on up-shifting, when the input shaft system is to be slowed down, unsynchronized automatic gearboxes are often equipped with what is known as a gearbox brake. The gearbox brake can also be used on starting a stationary vehicle. In this connection, the engine is running, the clutch is not disengaged, and the gear selector is in neutral position, for example after power take-off operation. In this case of application, the input shaft system of the gearbox rotates while the output shaft system is stationary. When the gear selector is moved into a drive position (forward or reverse), engagement of a gear in order to drive off or launch travel (that is to say the starting gear) can begin. In this connection, the adaptation of the speed of rotation of the running wheels of the starting gear cannot take place by controlling the engine speed because this case would require that the engine be switched off. Instead, the following procedural steps must be performed: (1) disengagement of the gearbox from the output shaft of the engine; (2) reduction of the speed of rotation of the input shaft system, for example by a gearbox brake; and (3) engagement of the starting gear when the speed of rotation of the running wheel concerned is sufficiently low.

The gearbox brake increases complexity and cost of the overall assembly. Removing it, however, means that the speeds of the input shaft system can be reduced only as a consequence of the inner frictional resistance of the gearbox. A period of time of roughly two seconds is normally needed in order to bring the speed of rotation down to the desired level in this way in order to make it possible to engage the starting gear. As this time delay takes place after the driver has moved the gear selector into the new position, the delay is experienced as a very negative effect.

### Summary of Invention

One objective of the invention is to produce a control means that makes it possible to use an automated gearbox without a gearbox brake thereby obviating the disadvantages described above.

To this end, the control means according to the invention is characterized in that a detector is arranged so as to sense (detect) an actuation of the gearshift, which detector is connected to operating means for activating the disengagement arrangement. By virtue of this design of the control means, the disengagement arrangement can be activated more rapidly for reducing the time required for a gear-shifting operation.

A method of operation conducted according to the invention is characterized by the steps of detecting an actuation of the gearshift and of activating the disengagement arrangement in the event of such a detection.

### Brief Description of Drawings

The invention will be described in greater detail below with reference to an illustrative embodiment that is shown in the accompanying drawing wherein:

Figure 1 is a schematic block diagram of an internal combustion engine with an automated transmission and a gearshift method and arrangement conducted and configured according to the presently disclosed invention.

### Detailed Description

The figure shows schematically a drive line belonging to a vehicle and including an engine 10, a gearbox 11 and a clutch 12 positioned between the engine and the gearbox. The gearbox 11 can, for example, be provided with what is known as a split unit that provides two possible gearings from the input shaft to the intermediate shafts. The basic unit of the gearbox can be provided with four forward gears and a reverse gear. The gearbox can also include what is known as a range unit that provides another two possible gearings from the main shaft to the output shaft. In total, there are then 16 forward, and four reverse gear combinations.

The clutch 12 is mechanical and provided with a side 13 connected to the engine 10 and also a disengageable, output side 14 which is connected to the gearbox 11 via an input shaft 15. An output shaft 16 from the gearbox is connected in a known manner to the driving wheels of the vehicle. Operation of the clutch 12 is effected by means of a control device 17 that is operated by a microcomputer-based control unit 18 via an output 19.

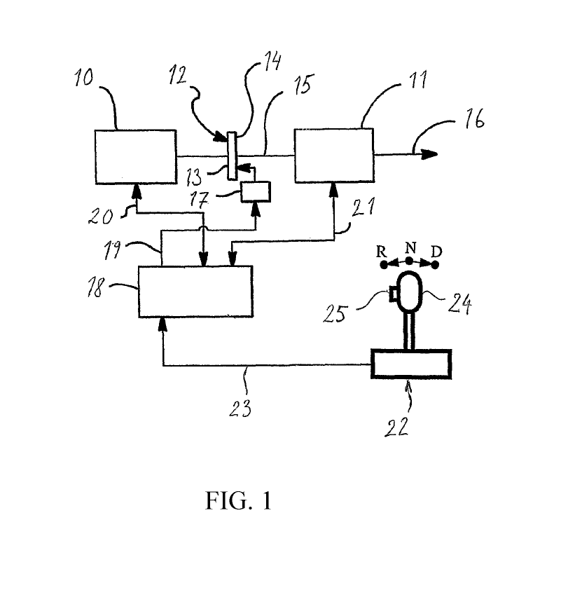

Input data to the control unit 18 is received, for example, via a connection 20 to the engine 10 and which provides information about the current engine speed. The control unit 18 also receives information about the current gear position via a connection 21. The connections 20 and 21 are two-way communication connections, which makes it possible, for example, for the control unit 18 on the one hand to influence the engine speed by activating a suitable arrangement, for example, an exhaust brake, and on the other hand to control the gear position of the gearbox as well. The control unit 18 also receives input data from a gear selector 22 via a connection 23. The gear selector 22 is provided with a lever 24 having a neutral position lock 25. There are three possible use positions illustrated in Fig. 1: (1) N for neutral position, (2) D for drive (forward) position, and (3) R for reverse. More positions on the selector are possible, as are addition control or actuation knobs.

The gear selector 22 is preferably provided with a detector that is arranged so as to sense whether the lever 24 is actuated, for example by the lever being moved from the N position. Alternatively, the detector is arranged so as to sense whether the neutral lock 25 has been pressed in, which takes place before the gear selector can leave the N position. The signal from the detector activates the control device 17 via the connections 19, 23 and also the control unit 18, the clutch 12 being disengages. The adaptation of the speed of rotation of the running wheels of the gearbox can then take place without delay, either through the effect of the inner rotational resistance of the gearbox, or by using a gearbox brake. On detection of the desired speed of rotation for engaging a gear having been obtained, the shifting operation takes place automatically via the control unit 18.

The gear selector described above therefore makes possible rapid engagement of a starting gear, without the need for a gearbox brake for adapting the speed of rotation of the running wheels of the starting gear.

The invention is not to be considered as being limited to the illustrative embodiments described above, but a number of further variants and modifications are possible within the scope of the patent claims presented below.

Claims

1. A gearshift assembly for operating an automated transmission for a motor vehicle, said assembly comprising:
a disengagement arrangement positioned in the drive line between an engine and the gearbox of the vehicle, which gearbox can be operated between a neutral position and at least one drive position by operating a gearshift between a corresponding neutral position (N) and at least one corresponding drive position (D); and
a detector arranged to detect an actuation of the gearshift, said detector being connected to an operating means for activating the disengagement arrangement.

2. The assembly as recited in claim 1, wherein the detector is adapted to detect a movement of the gearshift from the neutral position (N).

3. The assembly as recited in claim 1, wherein the detector is adapted to detect an actuation of a neutral position lock arranged at the gearshift.

4. A method for operating an automated transmission for a motor vehicle, said method comprising:
positioning a disengagement arrangement in the drive line between an engine and a gearbox of a vehicle, said gearbox being operable between a neutral position and at least one drive position by operating a gearshift between a corresponding neutral position (N) and at least one corresponding drive position (D); and
detecting an actuation of the gearshift, and of activating the disengagement arrangement in the event of such a detection.

5. The method as recited in claim 4, wherein the gearbox is operated so as to go into a drive position when the speed of rotation of associated running wheels is sufficiently low.
